(19) United States
(12) Patent Application Publication
(10) Pub. No.: US 2004/0040473 A1
(43) Pub. Date: Mar. 4, 2004

(54) Compositions for use in making models

(76) Inventor: Jose Walter, Centerville, VA (US)

Correspondence Address: Hendricks and Associates, P.O. Box 2509, Fairfax, VA, 22031-2509, US

(21) Appl. No.: 10/232,656

(22) Filed: Sep. 3, 2002

(51) Int. Cl. C04B 2/10; C04B 9/04; C04B 11/00

(52) U.S. Cl. 106/778

(57) ABSTRACT

A gypsum-based molding material is customized by hydrating the molding material to workable (malleable) consistency with a moistening solution containing 0.001% to 35% polytetrafluoroethylene.

### FIELD OF THE INVENTION

This invention relates to compositions for use in making dental models having improved strength.

### BACKGROUND OF THE INVENTION

In making models for restorative and replacement in dentistry, it is important that the materials used be both workable and of sufficient strength to provide models that are sharp and do not crumble. It is sometimes necessary to stock various types of materials of varying strength in order to have materials that are optimum to the particular purpose for which the models are made. Models are created using a negative impression of the object of interest. The negative impression is then filled with a casting material which hardens, thus creating a models of the object to be made or modified. In order to work with these models, the casting material must sometimes be sawed into smaller pieces. It is essential to be able to realign the pieces in the appropriate manner and to have materials which hold their shape without crumbling, but which can be worked on and reassembled.

### SUMMARY OF THE INVENTION

It is the purpose of this invention to provide materials for making customized molding material for use in making models. A gypsum-based molding material is customized by hydrating the molding material to workable (malleable) consistency with a moistening solution containing 0.001 to 35% polytetrafluoroethylene.

### DETAILED DESCRIPTION OF THE INVENTION

It has now been found that addition of varying amounts of polytetrafluoroethylene (PTFE) to solution for moistening calcium sulfate (gypsum) containing molding materials for making models such as that used in making dental models will increase strength and sharpness of the models. The gypsum-based material as used in dentistry is often called “stone”. The amount of PTFE used in a particular application depends on the workability and strength required. When greater amounts of PTFE are used, the material may be harder to work, but will be less likely to crumble. While the materials described herein were developed for purposes of making dental models, the PTFE/gypsum-based molding material may be used for making any models such as those used in manufacturing of parts or packaging. Such applications have wide use in such industries as aerospace, automotive, laboratory and medical equipment industries.

### EXAMPLE

Compositions containing 58%-62% PTFE manufactured by Dupont were used in making the following compositions:

| Formula identification | % Dupont PTFE product | % water |
|---|---|---|
| 1 | 0.1% | 99.9% |
| 2 | 0.2% | 99.8% |
| 3 | 0.8% | 99.2% |
| 4 | 8.34% | 91.66% |
| 5 | 16.67% | 83.33% |
| 6 | 33.34% | 66.66% |

To each gallon of formulation, 2 drops of dye were added so that the materials containing the PTFE could be identified. Formulations 1-3, when used to hydrate gypsum-based molding material for making dental models in place of water usually used for hydration provided resin-like materials, produced a resin-like material upon drying. Similar additions of formulations 4-6 resulted in epoxy-like materials. The epoxy-like models were very smooth and hard when dried, but could be cut with appropriate saws to provide very strong models of the teeth. The formulations 1, 2 and 3 contain about 0.05% to 0.5% PTFE. Formulations 4, 5 and 6 contain about 9% to about 20% of the PTFE.

While the instant invention was developed originally for making models of teeth, it may be used in other applications such as making models of parts or openings in materials for which fittings are required to maintain shape.

When used to make molds, no polymerization step such as heating is needed. Simply moistening the material with a solution containing the desired amount of PTFE will, upon hardening, provide the desired hardness to the models formed when the material is used in accord with the teachings herein.

What we claim is:

1. A method of producing a customized hardening a gypsum-containing molding material by moistening dried gypsum-containing material with moistening solution containing from 0.001 to 35% polytetrafluoroethylene.

2. The method of claim 1 wherein the product is further used to make dental models.

3. The method of claim 1 wherein the solution containing polytetrafluoroethylene is an aqueous solution.

4. The method of claim 1 wherein said moistening solution contains 0.05% to 5% polytetrafluoroethylene.

5. The method of claim 1 wherein said moistening solution contains 9% to 20% polytetrafluoroethylene.

6. A composition of matter comprising a malleable gypsum-based molding material and a moistening solution containing 0.05% to 20% polytetrafluoroethylene.

7. The composition of claim 6 wherein the moistening solution contains 0.05% to 5% polytetrafluoroethylene.

8. The composition of claim 7 wherein the moistening solution contains 9% to 20% polytetrafluoroethylene.
